(19) United States
(12) Patent Application Publication
(10) Pub. No.: US 2022/0188620 A1
(43) Pub. Date: Jun. 16, 2022

(54) TIME ESTIMATOR FOR DEEP LEARNING ARCHITECTURE

(71) Applicant: INTERNATIONAL BUSINESS MACHINES CORPORATION, Armonk, NY (US)

(72) Inventors: Chao Xue, Beijing (CN); Lin Dong, Beijing (CN); Xi Xia, Beijing (CN); Zhi Hu Wang, Beijing (CN)

(21) Appl. No.: 17/117,458

(22) Filed: Dec. 10, 2020

(51) Int. Cl. G06N 3/08; G06F 16/2458; G06N 5/04

(52) U.S. Cl. CPC G06N 3/08; G06N 5/046; G06F 16/2477

(57) ABSTRACT

A method for optimizing a neural network architecture by estimating an inference time for each operator in the neural network architecture is provided. The method may include determining a benchmark time for at least one single-path architecture out of a plurality of single-path architectures associated with the neural network by sampling the at least one single-path architecture from the neural network, wherein the at least one single-path architecture comprises one or more operators. The method may further include, based on the benchmark time for the at least one single-path architecture, determining an estimated inference time for an operator, wherein determining the estimated inference time for the operator comprises, applying an operator function, wherein the operator function comprises a function based on a difference between the benchmark time associated with the at least one single-path architecture and the estimated latency of the neural network.

### BACKGROUND

The present invention relates generally to the field of computing, and more specifically, to optimizing neural networks by estimating an inference time for different operators in the neural network.

Generally, a neural network is a deep learning algorithm which may take an image as input, assign importance (learnable weights and biases) to various aspects/objects in the image and, in turn, differentiate one object from another in the image to produce a result. One type of neural network is a convolutional neural network (CNN) architecture. A classic use of CNNs is to set up multiple convolution layers, specify an output goal, and train the neural network on many labeled examples. For example, the CNN can be trained on one of several public datasets which may contain millions of images labeled with more than a thousand classes. As such, an image classifier CNN takes an image as input, processes its pixels through its many layers, and outputs a list of values that represent the probability that the image belongs to a specific class. The layers associated with the CNN may serve as operators for processing the data associated with the image.

Another type of neural network is a one-shot neural network architecture. Unlike CNNs, the one-shot neural network architecture does not use many labeled images to train its neural network. Specifically, instead of treating the task as a classification problem, one-shot learning turns it into a difference-evaluation problem. The key to one-shot learning is an architecture called the Siamese neural network. Specifically, the Siamese neural network is not much different from CNNs, in that it takes images as input and encodes their features into a set of numbers. The difference comes in the output processing. During the training phase, classic CNNs tune their parameters so that they can associate each image to its proper class. The Siamese neural network, on the other hand, trains to be able to measure the distance between the features in two input images. For example, when a deep learning model is adjusted for one-shot learning, it takes two images (e.g., a passport image and an image of the person looking at the camera) and returns a value that shows the similarity between the two images. If the images contain the same object (or the same face), the neural network returns a value that is smaller than a specific threshold (say, zero) and if they are not the same object, it will be higher than the threshold.

In any type of neural network, accuracy and run-time are typically key. Generally, the size of the neural network model is correlated with its accuracy. As the model size increases, the accuracy increases as well, and most real-world applications aim to achieve the highest accuracy with the lowest running inference time possible. Unlike the process for training a neural network, inference does not re-evaluate or adjust the layers of a neural network based on results. Inference applies knowledge from a trained neural network model and uses it to infer a result. So, when a new unknown data set is input through a trained neural network, inference outputs a prediction based on predictive accuracy of the neural network. Inference comes after training as it requires a trained neural network model.

### SUMMARY

A method for optimizing a neural network architecture by estimating an inference time for each operator in the neural network architecture is provided. The method may include determining a benchmark time for at least one single-path architecture out of a plurality of single-path architectures associated with the neural network by sampling the at least one single-path architecture from the neural network, wherein the at least one single-path architecture comprises one or more operators. The method may further include, based on the benchmark time for the at least one single-path architecture, determining an estimated inference time for an operator, wherein determining the estimated inference time for the operator comprises, applying an operator function, wherein the operator function comprises a function based on a difference between the benchmark time associated with the at least one single-path architecture and the estimated latency of the neural network.

A computer system for optimizing a neural network architecture by estimating an inference time for each operator in the neural network architecture is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include determining a benchmark time for at least one single-path architecture out of a plurality of single-path architectures associated with the neural network by sampling the at least one single-path architecture from the neural network, wherein the at least one single-path architecture comprises one or more operators. The method may further include, based on the benchmark time for the at least one single-path architecture, determining an estimated inference time for an operator, wherein determining the estimated inference time for the operator comprises, applying an operator function, wherein the operator function comprises a function based on a difference between the benchmark time associated with the at least one single-path architecture and the estimated latency of the neural network.

A computer program product for optimizing a neural network architecture by estimating an inference time for each operator in the neural network architecture is provided. The computer program product may include one or more computer-readable storage devices and program instructions stored on at least one of the one or more tangible storage devices, the program instructions executable by a processor. The computer program product may include program instructions to determine a benchmark time for at least one single-path architecture out of a plurality of single-path architectures associated with the neural network by sampling the at least one single-path architecture from the neural network, wherein the at least one single-path architecture comprises one or more operators. The method may further include, based on the benchmark time for the at least one single-path architecture, determining an estimated inference time for an operator, wherein determining the estimated inference time for the operator comprises, applying an operator function, wherein the operator function comprises a function based on a difference between the benchmark time associated with the at least one single-path architecture and the estimated latency of the neural network.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an exemplary diagram of a neural network architecture according to one embodiment;

FIG. 3 is a visual representation of the operational formulas for estimating an inference time for operators in the neural network architecture according to one embodiment;

FIG. 4 is an operational flowchart illustrating the steps carried out by a program for optimizing a neural network architecture by estimating an inference time for operators in the neural network architecture according to one embodiment

FIG. 5 is a block diagram of the system architecture of the program for optimizing a neural network architecture by estimating an inference time for operators in the neural network architecture according to one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

As previously described, embodiments of the present invention relate generally to the field of computing, and more particularly, to optimizing neural networks by estimating an inference time for different operators in the neural network. Specifically, the following described exemplary embodiments provide a system, method and program product for improving the neural network latency by identifying an inference time for each operator associated with a neural network more accurately. More specifically, the present invention has the capacity to improve the technical field associated with on-screen keyboards by include determining a benchmark inference time for at least one single-path architecture out of a plurality of single-path architectures associated with the neural network by sampling the at least one single-path architecture from the neural network, wherein the at least one single-path architecture comprises one or more operators. Then, in turn, the method, computer system, and computer program product may determine an estimated inference time for each operator, wherein determining the estimated inference time for each operator comprises applying an operator function, wherein the operator function comprises a function based on a difference between the target inference time associated with the at least one single-path architecture and the estimated latency of the neural network. Accordingly, the present invention has the capacity to more accurately predict latency associated with a neural network by estimating inference times for each operator in the neural network.

As previously described with respect to neural networks, accuracy and run-time are typically key for neural networks. Generally, the size of the neural network model is correlated with its accuracy. Thus, as the model size increases, the accuracy increases as well, and most real-world applications of neural networks aim to achieve two metrics which include having the highest accuracy and the lowest inference running time possible. Currently, a differential method such as a differential architecture search (hereinafter, DARTS) may be used to estimate the accuracy metric associated with a neural network. Conversely, solutions such as floating point operations per second (FLOPS) and lookup table may be used to estimate inference time, however, these solutions typically include logging a clocked time of a neural network architecture that may not accurately and specifically represent the inference time of the neural network. Furthermore, current solutions do not accurately measure the inference time of specific operators in a neural network architecture, for example, by estimating the time that will be consumed by each operator in a neural network (operators such as a convolution layer operator, a pooling operator, etc.). As such, it may be advantageous, among other things, to provide a method, computer system, and computer program product for optimizing neural networks by estimating an inference time for each operator in the neural network to improve time and accuracy associated with a neural network.

Specifically, the method, computer system, and computer program product may include determining a benchmark inference time for at least one single-path architecture out of a plurality of single-path architectures associated with the neural network by sampling the at least one single-path architecture from the neural network, wherein the at least one single-path architecture comprises one or more operators. The method, computer system, and computer program product may further include based on the target inference time for the at least one single-path architecture, determining an estimated inference time for an operator, wherein determining the estimated inference time for the operator comprises applying an operator function associated with the operator, wherein the operator function comprises a function based on a difference between the target inference time associated with the at least one single-path architecture and the estimated latency of the neural network. The method, computer system, and computer program product may further include applying a random search algorithm to the determined estimated inference time for the operator to determine an optimal goal for the operator in the neural network.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

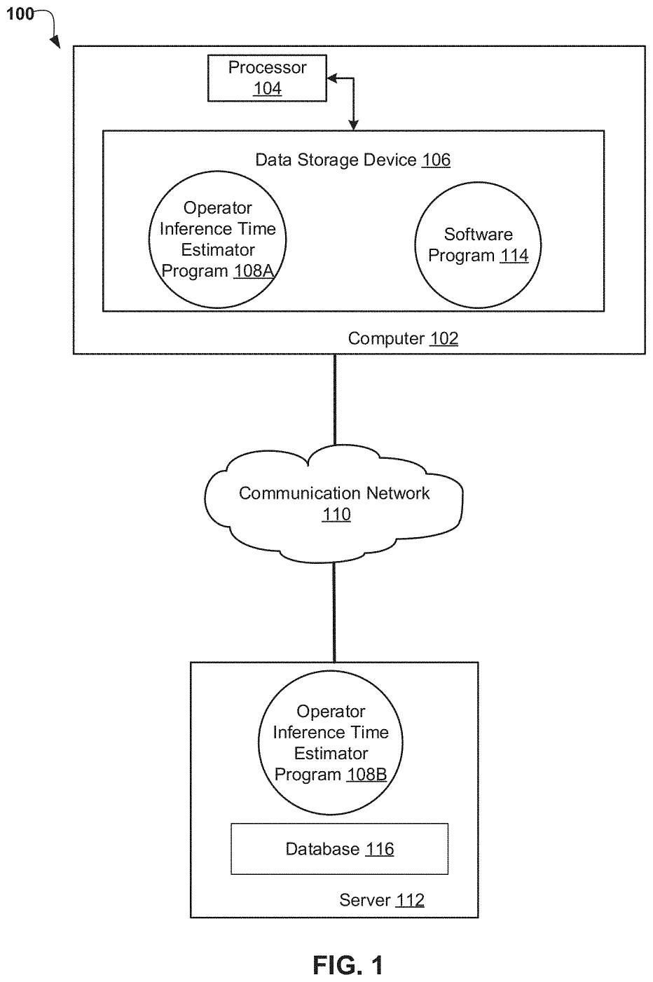

Referring now to FIG. 1, an exemplary networked computer environment 100 in accordance with one embodiment is depicted. The networked computer environment 100 may include a computer 102 with a processor 104 and a data storage device 106 that is enabled to run a benchmark-based operator estimator program 108A and a software program 114, and may also include a microphone (not shown). The software program 114 may be an application program such as a neural network and/or one or more mobile apps running on a client computer 102, such as a desktop, laptop, tablet, and mobile phone device. The benchmark-based operator estimator program 108A may communicate with the software program 114. The networked computer environment 100 may also include a server 112 that is enabled to run a benchmark-based operator estimator program 108B and the communication network 110. The networked computer environment 100 may include a plurality of computers 102 and servers 112, only one of which is shown for illustrative brevity. For example, the plurality of computers 102 may include a plurality of interconnected devices, such as the mobile phone, tablet, and laptop, associated with one or more users.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

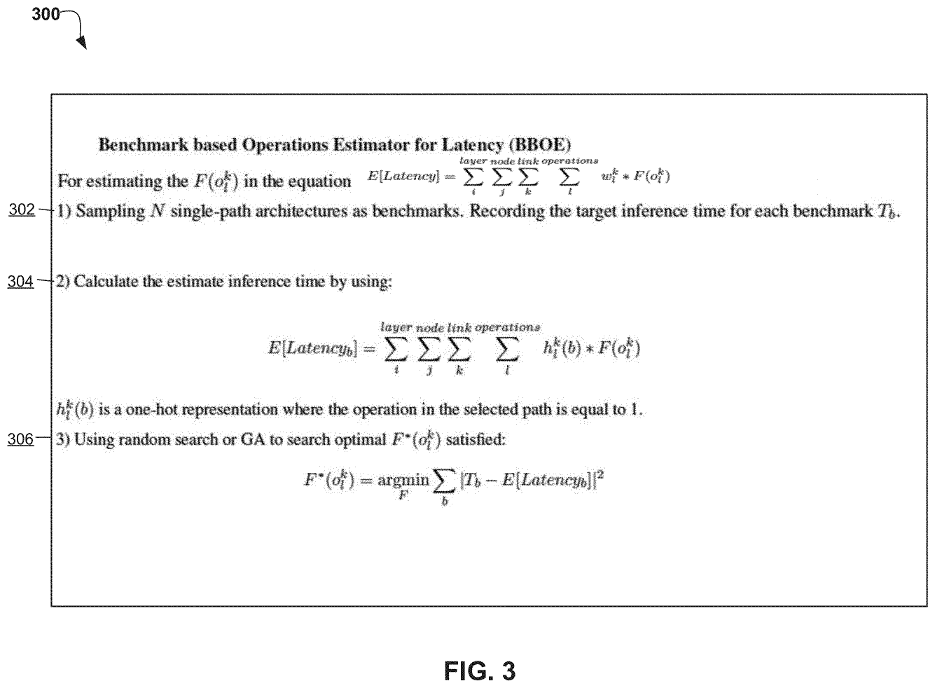

The client computer 102 may communicate with server computer 112 via the communications network 110. The communications network 110 may include connections, such as wire, wireless communication links, or fiber optic cables. As will be discussed with reference to FIG. 3, server computer 112 may include internal components 800a and external components 900a, respectively, and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the benchmark-based operator estimator program 108A, 108B may interact with a database 116 that may be embedded in various storage devices, such as, but not limited to, a mobile device 102, a networked server 112, or a cloud storage service.

According to the present embodiment, a program, such as a benchmark-based operator estimator program 108A and 108B may run on the client computer 102 and/or on the server computer 112 via a communications network 110. The benchmark-based operator estimator program 108A, 108B may optimizing neural networks by estimating an inference time for different operators in the neural network. Specifically, a user using a client computer 102, such as a laptop device, may run a benchmark-based operator estimator program 108A, 108B that may interact with a software program 114, such as a neural network program, to estimate an inference time for different operators in the neural network by determining a benchmark inference time for at least one single-path architecture out of a plurality of single-path architectures associated with the neural network based on sampling the at least one single-path architecture from the neural network, wherein the at least one single-path architecture comprises one or more operators. Then, benchmark-based operator estimator program 108A, 108B may determine the estimated inference time for each operator by applying an operator function, wherein the operator function comprises a function based on a difference between the benchmark time associated with the at least one single-path architecture and the estimated latency of the neural network.

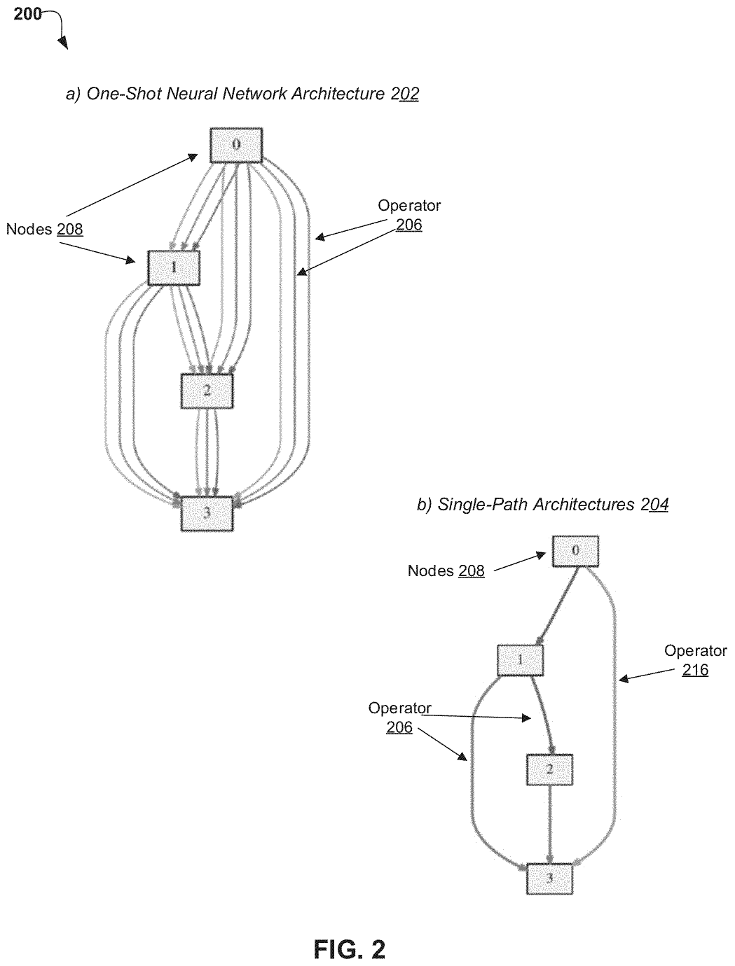

Referring now to FIG. 2, an exemplary diagram 200 of a neural network architecture according to an embodiment of the present invention is depicted. Specifically, in FIG. 2, (a) is a one-shot neural network architecture 202, and (b) are examples of different single-path architectures 204 that are sampled from (a) the one-shot neural network architecture. Specifically, the benchmark-based operator estimator program 108A, 108B may sample single-path architectures in order to estimate an operator's latency, where each edge/line 206 denotes an operator. More specifically, each operator 206 may represent an operation in the neural network, for example, one operator/line 206 may be a convolution node layer operation (i.e. 3*3 layer) while another operator/line 206 may be a pruning operation. Additionally, each node 208 may be a feature map associated with the neural network. Each node 208 may also be linked, whereby the nodes 208 are linked together by the operators 206. For example, node ‘0’ may have 3 links: whereby a first link may be node ‘0’ to node ‘1’, a second link may be node ‘0’ to node ‘2’, and a third link may be node ‘0’ to node ‘3’. Accordingly, a single path may be defined as the path between one node and another node which could include one or more operators.

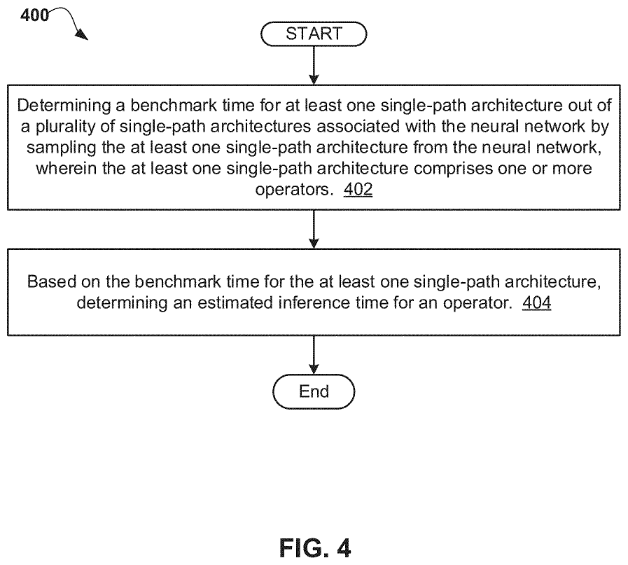

The benchmark-based operator estimator program 108A, 108B may sample multiple different single path architectures 204 between nodes 208 in order to form benchmark times for each of the single-path architectures. An example of a single path architecture is depicted in a path between node ‘0’ and node ‘3’ where the line 316 is a representation of an operator in the path between node ‘0’ and node ‘3’. Other examples of single-path architecture may include the path between node ‘0’ and node ‘1’, the path between node ‘1’ and node ‘2’, and the path between node ‘2’ and node ‘3’. According to one embodiment, the paths may include multiple different operators 216 between nodes 208 (for illustrative brevity, only one operator is shown between nodes 208 in (b) at 204). The benchmark-based operator estimator program 108A, 108B may sample multiple single-path architectures between the different nodes, whereby each of the sampled single-path architectures may include different operators, and benchmark-based operator estimator program 108A, 108B may determine a timing benchmark for each of the single-path architectures based on the sampled data. In turn, and as will be described with respect to FIGS. 3 and 4, the benchmark-based operator estimator program 108A, 108B may use the benchmarks in a formula to estimate the inference times of each of the different operators associated with the single-path architectures. Specifically, the benchmark-based operator estimator program 108A, 108B may determine a benchmark by recording a target inference time for each single path architecture, whereby the recorded target inference time of a single path architecture is a target because it may be used to estimate inference time of an operator 206.

Referring now to FIG. 3, a visual representation 300 of operational formulas for estimating an inference time for operators in the neural network architecture according to an embodiment of the present invention is depicted. Generally, a predictive model for determining the estimated latency for a neural network architecture may be represented by the following formula:

E[Latency]=F(architecture)
where E[Latency] represents the estimated latency, and
F(architecture) is the neural network architecture.
   Furthermore, the estimated latency for the neural network architecture may be further be drawn out and depicted in the following formula:

$$E [ Latency ] = {\sum }_{i}^{layer} {\sum }_{j}^{node} {\sum }_{k}^{link} {\sum }_{l}^{operations} {w}_{l}^{k} * F ( {o}_{l}^{k} ) \qquad ( 2 )$$

where E[Latency] represents the estimated latency of the neural network,
where i are layers, j are nodes, k are links, and l are operators,
where wₗ^{k} are a weighted values for links and operators associated with the neural network,
where F(oₗ^{k}) is a function of the estimated inference time for an operator.

With respect to FIG. 3, and as previously described, the benchmark-based operator estimator program 108A, 108B may specifically estimate the inference time for each operator. As indicated in step 1 of FIG. 3 at 302, the benchmark-based operator estimator program 108A, 108B may start by sampling N single path architectures associated with a neural network. In turn, based on the sampling of the single-path architectures, the benchmark-based operator estimator program 108A, 108B may determine for each of the single-path architectures a timing benchmark by recording a target inference time for each single path architecture. As such, the benchmark-based operator estimator program 108A, 108B may use a revised version of the formula as described in steps 2 and 3 of FIG. 3 to estimate the inference time of an operator. Specifically, using the following formula in step 2 at 304, the benchmark-based operator estimator program 108A, 108B may estimate the inference time for each operator:

$$E [ {Latency}_{b} ] = {\sum }_{i}^{layer} {\sum }_{j}^{node} {\sum }_{k}^{link} {\sum }_{l}^{operations} {h}_{l}^{k} ( b ) * F ( {o}_{l}^{k} ) \qquad ( 3 )$$

where E(Latency_{b}) is the estimated benchmark latency for the neural network based on the benchmarks associated with the sampled single-path architectures,
where i are layers, j are nodes, k are links, and l are operators associated with the neural network,
where kₗ^{k}(b) is a one-hot representation where the operator/operation in the selected path is equal to 1, and
where F(oₗ^{k}) is a function of the estimated inference time for operators.
   Specifically, according to one embodiment, the benchmark-based operator estimator program 108A, 108B may use a one-hot representation where the operator in the selected path is equal to 1 so that the inference time for only that operator may be determined. Furthermore, the benchmark-based operator estimator program 108A, 108B may derive the following formula depicted in step 3 of FIG. 3 at 306 based on the above formula, for determining the estimated inference time for a specific operator:

$${F}^{*} ( {o}_{l}^{k} ) = {arg min}_{F} {\sum }_{b} {\vert {T}_{b} - E [ {Latency}_{b} ] \vert}^{2} \qquad ( 4 )$$

where F(oₗ^{l}) is a function of the estimated inference time for an operator,
where E[Latency_{b}] is the estimated latency for the neural network,
where T_{b} is a benchmark (target inference time) of a single-path architecture associated with the operator, and
where

$${arg min}_{F}$$

is a function.

According to one embodiment, the benchmark-based operator estimator program 108A, 108B may use the benchmarks associated with the single-path architectures to estimate the latency of the for the neural network. Specifically, the benchmark of a single-path architecture (Tb) may be known based on sampling the single-path architectures and the benchmarks may be used to estimate the latency for the neural network. For example, considering benchmarks may be determined for single-path architectures in a neural network, the benchmark-based operator estimator program 108A, 108B may use the above formula to determine a true latency associated with an operator associated with the single-path architectures. More specifically, for example, the benchmark-based operator estimator program 108A, 108B may determine one benchmark to be 5 ms and another benchmark to be 10 ms. Thereafter, the benchmark-based operator estimator program 108A, 108B may use the benchmarks to estimate the latency of the neural network. Thereafter, the benchmark-based operator estimator program 108A, 108B may estimate each operator's latency (i.e. F).

Furthermore, in step 3 of FIG. 3 at 306, the benchmark-based operator estimator program 108A, 108B may use random search algorithm that may generate a value randomly and calculate a goal, and then compare the goals to find a best value. The benchmark-based operator estimator program 108A, 108B may also specifically use a genetic algorithm (GA) in place of a random search.

In FIG. 4, an operational flowchart 400 illustrating the steps carried out by the benchmark-based operator estimator program 108A, 108B for optimizing a neural network architecture by estimating an inference time for operators in the neural network architecture will be described in greater detail with reference to FIG. 4. Specifically, with respect to FIG. 4 at 402, and as previously described in FIGS. 2 and 3, the benchmark-based operator estimator program 108A, 108B may sample single-path architectures. More specifically, and as previously described with respect to FIG. 2, the benchmark-based operator estimator program 108A, 108B may sample multiple different single path architectures 204 (FIG. 2) between nodes 208 (FIG. 2) whereby the sampled single-path architectures may include one or more operators.

Based on the sampled single-path architectures, the benchmark-based operator estimator program 108A, 108B may determine a benchmark time for each of the sampled single-path architectures. Specifically, the benchmark-based operator estimator program 108A, 108B may determine a timing benchmark by recording a target inference time for each single path architecture, whereby the timing benchmark based on the recorded target inference time of a single path architecture may be used in a formula to estimate the inference time of an operator.

In turn, and as depicted in FIG. 4 at 404, the benchmark-based operator estimator program 108A, 108B may determine the inference time for specific operators. Specifically, the benchmark-based operator estimator program 108A, 108B may use the following formula to estimate the inference time for an operator:

$${F}^{*} ( {o}_{l}^{k} ) = {arg min}_{F} {\sum }_{b} {\vert {T}_{b} - E [ {Latency}_{b} ] \vert}^{2} \qquad ( 4 )$$

where f(oₗ^{k}) is a function of the estimated inference time for an operator,
where E[Latency_{b}] is the estimated latency for the neural network,
where T_{b} is a benchmark (target inference time) of a single-path architecture associated with the operator, and
where

$${arg min}_{F}$$

is a function.

Furthermore, the benchmark-based operator estimator program 108A, 108B may use a random search, i.e. a search algorithm, that may generate a value randomly and determine an optimal goal for each operator (i.e. compare values to find a best value for F). Specifically, the benchmark-based operator estimator program 108A, 108B may solve the argmin function by randomly assigning values for F, and then calculate the square root error of |Tb-E(latency)|\hat{ }2. Then, after selecting random values for F, the benchmark-based operator estimator program 108A, 108B may determine an optimal value for F.

In turn, the benchmark-based operator estimator program 108A, 108B may optimize the neural network by more accurately estimating the latency associated with the neural network. Specifically, by determining the estimated inference time for each specific operator, the benchmark-based operator estimator program 108A, 108B may use the values for the estimated inference time of each operator to plug into the following formula depicted in step 2 of FIG. 3:

$$E [ {Latency}_{b} ] = {\sum }_{i}^{layer} {\sum }_{j}^{node} {\sum }_{k}^{link} {\sum }_{l}^{operations} {h}_{l}^{k} ( b ) * F ( {o}_{l}^{k} ) \qquad ( 3 )$$

where E[Latency_{b}] is the estimated benchmark latency for the neural network based on the benchmarks associated with the sampled single-path architectures,

where i are layers, j are nodes, k are links, and l are operators associated with the neural network,

where hₗ^{k}(b) is a one-hot representation where the operator/operation in the selected path is equal to 1, and

where F(oₗ^{k}) is the estimated inference time for operators.

In turn, the benchmark-based operator estimator program 108A, 108B may use the value for the estimated latency of the neural network to more accurately determine a loss for the neural network. Specifically, a loss function is a component of the neural network, where loss is a prediction error of the neural network. More specifically, the loss is used to calculate the gradients, and gradients are used to update the neural network which is how a neural network is trained. A formula for determining the loss is called a loss function, which may be represented by the following formula:

Loss=Loss_{cross_entropy}+λE[Latency]

where λE[Latency] may be the value for the estimated latency of the neural network that is more accurately determined based on the process described above.

It may be appreciated that FIGS. 2-4 provide only illustrations of one implementation and does not imply any limitations with regard to how different embodiments may be implemented. Many modifications to the depicted environments may be made based on design and implementation requirements.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

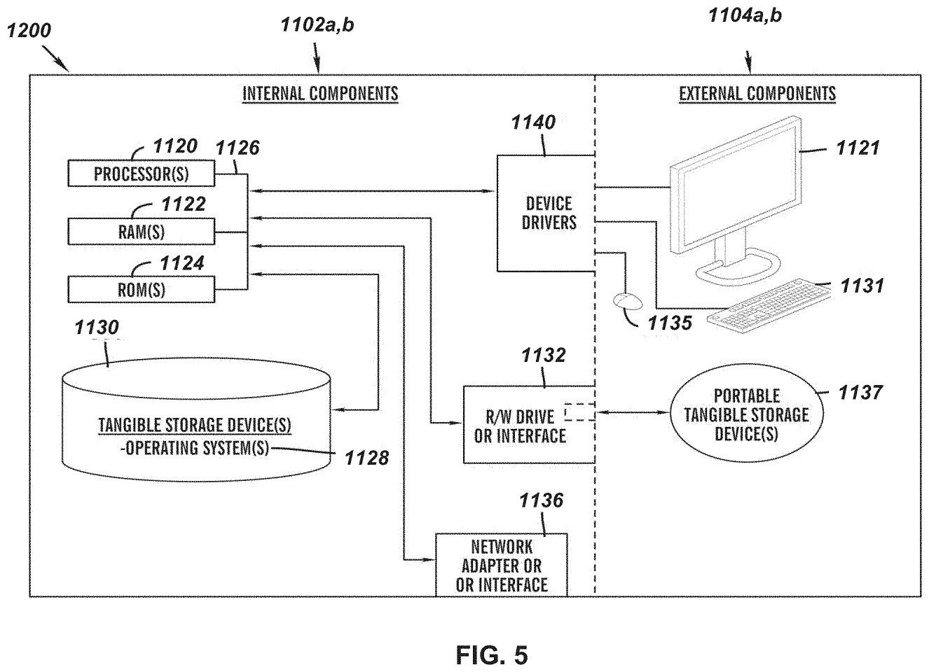

FIG. 5 is a block diagram 1100 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 110, 1104 is representative of any electronic device capable of executing machine-readable program instructions. Data processing system 1102, 1104 may be representative of a smart phone, a computer system, PDA, or other electronic devices. Examples of computing systems, environments, and/or configurations that may represented by data processing system 1102, 1104 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 1102a, b and external components 1104a, b illustrated in FIG. 5. Each of the sets of internal components 1102a, b includes one or more processors 1120, one or more computer-readable RAMs 1122, and one or more computer-readable ROMs 1124 on one or more buses 1126, and one or more operating systems 1128 and one or more computer-readable tangible storage devices 1130. The one or more operating systems 1128, the software program 114 (FIG. 1) and the benchmark-based operator estimator program 108A (FIG. 1) in client computer 102 (FIG. 1), and the benchmark-based operator estimator program 108B (FIG. 1) in network server computer 112 (FIG. 1) are stored on one or more of the respective computer-readable tangible storage devices 1130 for execution by one or more of the respective processors 1120 via one or more of the respective RAMs 1122 (which typically include cache memory). In the embodiment illustrated in FIG. 5, each of the computer-readable tangible storage devices 1130 is a magnetic disk storage device of an internal hard drive. Alternatively, each of the computer-readable tangible storage devices 1130 is a semiconductor storage device such as ROM 1124, EPROM, flash memory or any other computer-readable tangible storage device that can store a computer program and digital information.

Each set of internal components 1102a, b, also includes a R/W drive or interface 1132 to read from and write to one or more portable computer-readable tangible storage devices 1137 such as a CD-ROM, DVD, memory stick, magnetic tape, magnetic disk, optical disk or semiconductor storage device. A software program, such as a benchmark-based operator estimator program 108A and 108B (FIG. 1), can be stored on one or more of the respective portable computer-readable tangible storage devices 1137, read via the respective RAY drive or interface 1132, and loaded into the respective hard drive 1130.

Each set of internal components 1102a, b also includes network adapters or interfaces 1136 such as a TCP/IP adapter cards, wireless Wi-Fi interface cards, or 3G or 4G wireless interface cards or other wired or wireless communication links. The benchmark-based operator estimator program 108A (FIG. 1) and software program 114 (FIG. 1) in client computer 102 (FIG. 1), and the benchmark-based operator estimator program 108B (FIG. 1) in network server 112 (FIG. 1) can be downloaded to client computer 102 (FIG. 1) from an external computer via a network (for example, the Internet, a local area network or other, wide area network) and respective network adapters or interfaces 1136. From the network adapters or interfaces 1136, the benchmark-based operator estimator program 108A (FIG. 1) and software program 114 (FIG. 1) in client computer 102 (FIG. 1) and the benchmark-based operator estimator program 108B (FIG. 1) in network server computer 112 (FIG. 1) are loaded into the respective hard drive 1130. The network may comprise copper wires, optical fibers, wireless transmission, routers, firewalls, switches, gateway computers, and/or edge servers.

Each of the sets of external components 1104a, b can include a computer display monitor 1121, a keyboard 1131, and a computer mouse 1135. External components 1104a, b can also include touch screens, virtual keyboards, touch pads, pointing devices, and other human interface devices. Each of the sets of internal components 1102a, b also includes device drivers 1140 to interface to computer display monitor 1121, keyboard 1131, and computer mouse 1135. The device drivers 1140, R/W drive or interface 1132, and network adapter or interface 1136 comprise hardware and software (stored in storage device 1130 and/or ROM 1124).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

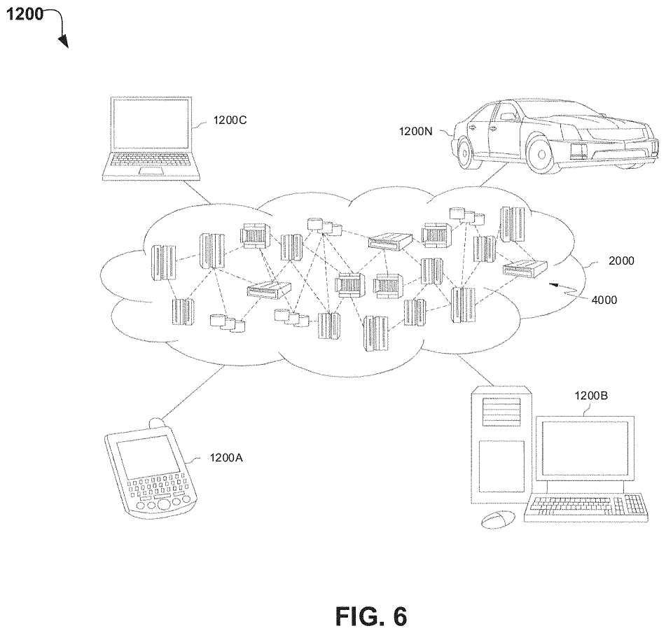

Referring now to FIG. 6, illustrative cloud computing environment 1200 is depicted. As shown, cloud computing environment 1200 comprises one or more cloud computing nodes 4000 with which local computing devices used by cloud consumers, such as, for example, personal digital assistant (PDA) or cellular telephone 1200A, desktop computer 1200B, laptop computer 1200C, and/or automobile computer system 1200N may communicate. Nodes 4000 may communicate with one another. They may be grouped (not shown) physically or virtually, in one or more networks, such as Private, Community, Public, or Hybrid clouds as described hereinabove, or a combination thereof. This allows cloud computing environment 2000 to offer infrastructure, platforms and/or software as services for which a cloud consumer does not need to maintain resources on a local computing device. It is understood that the types of computing devices 1200A-N shown in FIG. 8 are intended to be illustrative only and that computing nodes 4000 and cloud computing environment 2000 can communicate with any type of computerized device over any type of network and/or network addressable connection (e.g., using a web browser).

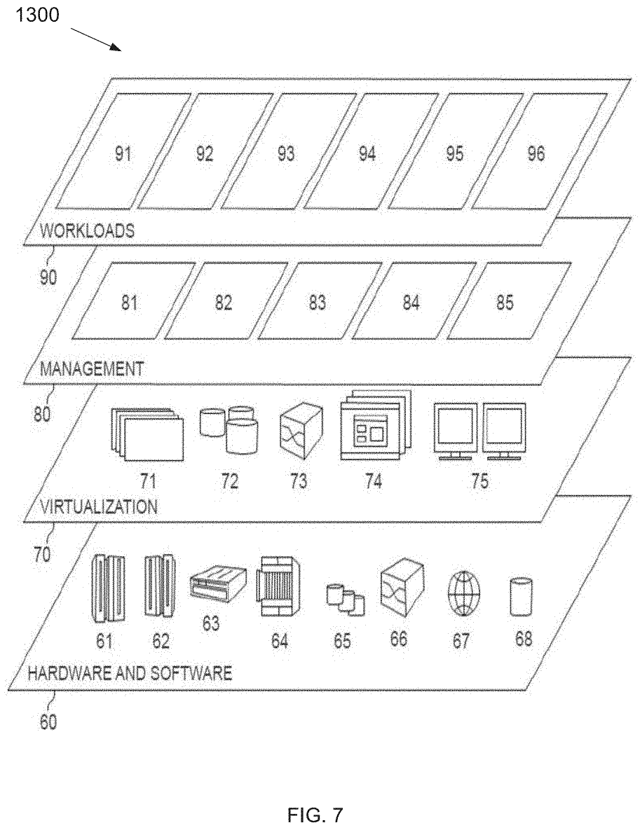

Referring now to FIG. 7, a set of functional abstraction layers 1300 provided by cloud computing environment 1200 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and benchmark-based operator estimator 96. A benchmark-based operator estimator program 108A, 108B (FIG. 1) may be offered “as a service in the cloud” (i.e., Software as a Service (SaaS)) for applications running on computing devices 102 (FIG. 1) and may, on a computing device, optimize a neural network by estimating an inference time for operators in the neural network.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for optimizing a neural network by estimating an inference time for each operator in the neural network, the method comprising:
determining a benchmark time for at least one single-path architecture out of a plurality of single-path architectures associated with the neural network by sampling the at least one single-path architecture from the neural network, wherein the at least one single-path architecture comprises one or more operators; and
based on the benchmark time for the at least one single-path architecture, determining an estimated inference time for an operator, wherein determining the estimated inference time for the operator comprises:
applying an operator function, wherein the operator function comprises a function based on a difference between the benchmark time associated with the at least one single-path architecture and the estimated latency of the neural network.

2. The method of claim 1, wherein the determined benchmark time for the at least one single-path architecture is based on a recorded inference time for the at least one single-path architecture.

3. The method of claim 1, further comprising:
applying a random search algorithm to the determined estimated inference time for the operator to determine an optimal goal for the operator in the neural network.

4. The method of claim 1, wherein the operator function is based on one or more links associated with the operator.

5. The method of claim 1, wherein the function associated with the operator function is an argmin function.

6. The method of claim 1, further comprising:
using the determined estimated inference time for the operator in an operation to determine the estimated latency of the neural network.

7. The method of claim 6, further comprising:
determining a loss for the neural network based on the estimated latency of the neural network.

8. A computer system for optimizing a neural network by estimating an inference time for each operator in the neural network, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
determining a benchmark time for at least one single-path architecture out of a plurality of single-path architectures associated with the neural network by sampling the at least one single-path architecture from the neural network, wherein the at least one single-path architecture comprises one or more operators; and
based on the benchmark time for the at least one single-path architecture, determining an estimated inference time for an operator, wherein determining the estimated inference time for the operator comprises:
applying an operator function, wherein the operator function comprises a function based on a difference between the benchmark time associated with the at least one single-path architecture and the estimated latency of the neural network.

9. The computer system of claim 8, wherein the determined benchmark time for the at least one single-path architecture is based on a recorded inference time for the at least one single-path architecture.

10. The computer system of claim 8, further comprising:
applying a random search algorithm to the determined estimated inference time for the operator to determine an optimal goal for the operator in the neural network.

11. The computer system of claim 8, wherein the operator function is based on one or more links associated with the operator.

12. The computer system of claim 8, wherein the function associated with the operator function is an argmin function.

13. The computer system of claim 8, further comprising:
using the determined estimated inference time for the operator in an operation to determine the estimated latency of the neural network.

14. The computer system of claim 13, further comprising:
determining a loss for the neural network based on the estimated latency of the neural network.

15. A computer program product for optimizing a neural network by estimating an inference time for each operator in the neural network, comprising:
one or more tangible computer-readable storage devices and program instructions stored on at least one of the one or more tangible computer-readable storage devices, the program instructions executable by a processor, the program instructions comprising:
program instructions to determine a benchmark time for at least one single-path architecture out of a plurality of single-path architectures associated with the neural network by sampling the at least one single-path architecture from the neural network, wherein the at least one single-path architecture comprises one or more operators; and
program instructions to determine, based on the benchmark time for the at least one single-path architecture, an estimated inference time for an operator, wherein determining the estimated inference time for the operator comprises:
program instructions to apply an operator function, wherein the operator function comprises a function based on a difference between the benchmark time associated with the at least one single-path architecture and the estimated latency of the neural network.

16. The computer program product of claim 15, wherein the determined benchmark time for the at least one single-path architecture is based on a recorded inference time for the at least one single-path architecture.

17. The computer program product of claim 15, further comprising:
program instructions to apply a random search algorithm to the determined estimated inference time for the operator to determine an optimal goal for the operator in the neural network.

18. The computer program product of claim 15, wherein the function associated with the operator function is an argmin function.

19. The computer program product of claim 15, further comprising:
program instructions to use the determined estimated inference time for the operator in an operation to determine the estimated latency of the neural network.

20. The computer program product of claim 19, further comprising:
program instructions to determine a loss for the neural network based on the estimated latency of the neural network.
